(19) United States
(12) Patent Application Publication
(10) Pub. No.: US 2020/0403225 A1
(43) Pub. Date: Dec. 24, 2020

(54) MATERIALS AND METHODS FOR ELECTRODE FABRICATION

(71) Applicant: CAMX Power LLC, Lexington, MA (US)

(72) Inventor: Adrian W. Pullen, Boston, MA (US)

(21) Appl. No.: 16/447,288

(22) Filed: Jun. 20, 2019

(51) Int. Cl. H01M 4/1315; H01M 4/13915; H01M 4/525; H01M 10/0525

(52) U.S. Cl. CPC H01M 4/1315; H01M 10/0525; H01M 4/525; H01M 4/13915

(57) ABSTRACT

Provided herein are materials for use and processes of forming a material suitable for use in coating an electrically conductive substrate as used in an electrode for an electrochemical cell. The processes combine a cathode active material, a binder comprising a halogenated hydrocarbon polymer, a solvent, and an additive suitable for reacting with a double unsaturation when formed on the binder, and intermixing the cathode slurry to produce a cathode coating material. The presence of the additive is to react with one or more conjugated dienes formed by reaction of the binder with the cathode active material or portion thereof so as to prevent gelling or unacceptable increases in viscosity during electrode formation or storage of the cathode coating material.

### FIELD

The present disclosure relates to the manufacture of lithium ion battery cathodes and improvements thereto.

### BACKGROUND

Lithiated transition metal oxides have become standard cathode materials for lithium ion batteries for almost every application. This class of materials was first introduced commercially as lithium cobalt oxide but as the industry has grown both cost and the need for greater energy density have required the introduction of progressively more nickel into the material. Although cheaper in cost and exhibiting higher discharge capacity, lithium nickel oxide unfortunately suffers from stability issues that can cause both manufacturing and product-life problems.

Modern products supplement nickel with one or more additional elements and often also include coatings intended to optimize both performance and cost. These materials, however, are still commonly very high in nickel and so, although they perform well, still suffer from some of the manufacturing issues associated with lithium nickel oxide. High among these problems is the tendency for the cathode material powder to react with the polymer binder during the cathode-manufacturing process, causing it to crosslink, form a gel and become un-processable.

Historically, when lithium cobalt oxide was the dominant cathode material type, high shear could be applied, essentially indefinitely, without penalty. Producers found that overmixing did not present a problem and subsequent pot-life for the coating slurry was unlimited. With the move to high nickel materials, this has proven to not be the case. The need for shear to enable powder dispersion is complicated by the gelling reaction that causes very short pot life for mixed slurries. This has generated the need for complicated shear and mixing regimens so that sufficient dispersion can be achieved but with reasonable pot life. Even with such regimens, the outcome can be unpredictable and unlimited pot life has never been possible.

As such, new materials and methods of production are necessary to improve processing and manufacture of cathode slurry material, cathodes, and electrochemical cells that employ them.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided are processes of forming a material suitable for use formation of a cathode for use in an electrochemical cell. The processes include a dienophile additive that is capable of reacting with a conjugated diene that may form within a binder by reaction with a hydroxide on the surface of a cathode active material optionally high nickel cathode active material. The processes include: forming a cathode slurry by combining a cathode active material, a binder comprising a halogenated hydrocarbon polymer, a solvent, and an additive suitable for reacting with a double unsaturation when formed on the binder; and intermixing the cathode slurry to produce a cathode coating material. A binder may include or may react with a component of the cathode slurry to form one or more conjugated dienes. The dienophile additive will react with this conjugated diene in a, optionally, cycloaddition reaction so as to prevent gelling of the cathode slurry either during shear or storage. An additive is optionally a dienophile, optionally including one or more electron withdrawing groups conjugated to an unsaturation between two carbons of the additive.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1 illustrates an electrochemical cell according to some aspects as provided herein;

FIG. 2 illustrates the effects of the addition of cyclohexene to a cathode coating slurry according to some aspects as provided herein;

FIG. 3 illustrates the effects of the addition of benzoquinone to a cathode coating slurry according to some aspects as provided herein;

FIG. 4 illustrates the effects of the addition of fluoranil to a cathode coating slurry according to some aspects as provided herein;

FIG. 5 illustrates the effects of the addition of maleic anhydride to a cathode coating slurry according to some aspects as provided herein;

FIG. 6 illustrates the effects of the addition of oxalic acid to a cathode coating slurry according to some aspects as provided herein;

FIG. 7 illustrates the effects of the addition of a dienophile and oxalic acid to a cathode coating slurry according to some aspects as provided herein;

FIG. 8 illustrates the effects of the addition of fluoranil to a cathode coating slurry including grain boundary enriched NCA as a cathode active material according to some aspects as provided herein;

FIG. 9 illustrates the effects of the addition of fluoranil to a cathode coating slurry including commercial NCA as a cathode active material according to some aspects as provided herein;

FIG. 10 illustrates the effects of the addition of fluoranil to a cathode coating slurry including NCM as a cathode active material according to some aspects as provided herein; and

FIG. 11 illustrates the effects on electrochemical performance of the addition of illustrative gelling inhibition additives to a cathode according to some aspects as provided herein.

### DETAILED DESCRIPTION

A primary issue in cathode manufacturing is reaction between components of the cathode electrode slurry that lead to gel formation and unworkability of the material. This disclosure provides new combinations of materials and methods to inhibit or stop this reaction between cathode active materials and binder, enabling straightforward processing, long to indefinite pot life of slurries, and uniform coatings but without significantly affecting the performance of the finished cathode.

The basis of this disclosure is a new understanding of the complex chemistry involved with gel formation when binder reacts with high Ni cathode active materials. The methods provided herein are particularly suited to the implementation of high-nickel cathode materials typically including 50 mole % Ni (relative to metals) or greater. Examples of these materials belong to the family of lithium transition metal oxide LiMO₂ whereby M is a mixture of Ni alone or in combination with one or more other elements illustratively, but not limited to Mn, Mg, Al, Ti, and/or Co.

Many cathode material products entering the market today exceed 80% nickel. Despite the inclusion of modifier elements, at these Ni levels the materials still possess many of the chemical characteristics of lithium nickel oxide. Among these characteristics is the tendency toward disorder at interfaces whereby the layered mineral structure gives way to a mixture of lithium and transition-metal oxides. At the powder particle surface, the lithium oxide rapidly becomes lithium hydroxide by reaction with atmospheric water, which has historically been virtually impossible to prevent even in bone-dry environments. Therefore, even the highest-quality products produced under optimal manufacturing conditions will all possess a thin layer of lithium hydroxide at the particle surfaces. It was found that this lithium hydroxide layer is the main reactant and cause of cathode slurry gelling during processing. This effect can occur even when the lithium hydroxide is present at very low levels including below 0.05 weight percent.

The most popular binder for lithium ion cathodes is polyvinylidene difluoride (PVDF); a hydrocarbon polymer but with roughly half the hydrogens bound to the carbon backbone replaced by fluorine. PVDF is soluble in N-methyl pyrrolidone (NMP) making this polymer/solvent pair a standard in the industry for making cathode coatings. The polymer serves two roles in the cathode; one is as a binder to provide the finished cathode coating with adhesive and cohesive structure. The other is as a dispersant for the cathode material powder when mixed in the solvent (e.g. NMP) solution. This dispersant role is activated by shear and is evident in the reduction of viscosity over time during shear for a cathode slurry. Shear drives polymer adsorption to the surface of the powder particles that, over time, causes particles to separate, become well dispersed, and the blend viscosity to reach a minimum value.

The gelling problem of these cathode electrode slurries is a reaction between the binder and the cathode active material powders. In this gelling reaction, halogenated hydrocarbon polymer binders such as PVDF or PVDC, react with alkali hydroxides such as LiOH. This reaction is a dehydrohalogenation whereby, for PVDF, hydrogen fluoride is extracted leaving behind an unsaturation on the polymer material. It was found that while such unsaturations are undesirable for the polymer chemistry in the electrode, they in themselves do not cause the gelling observed. As the unsaturations build in the polymer backbone, adjacent unsaturations on a polymer chain become statistically more common. These adjacent double unsaturations can then react with single unsaturations on another polymer chain through a Diels Alder reaction, which in turn causes gelling through crosslinking of the polymer chains.

It was discovered that the amount of lithium hydroxide required to cause crosslinking is very low. In practice, the mass % LiOH in the cathode powder is irrelevant because, as the reaction is heterogeneous, it is the surface area over which it occurs and not the total amount that is relevant to reactivity. This fact reveals just how futile it is to attack the lithium hydroxide with acid, esters or alcohols as was previously done in attempts to inhibit a gelling reaction. Acid gelling inhibitors are a particularly poor choice because they will also strip off any passivating lithium carbonate coating that may be present on the hydroxide surface thus making the hydroxide even more reactive. Esters and alcohols will at least selectively react with LiOH but these, again, react directly with the LiOH and do not leave behind a passivating species but rather a fresh and reactive surface. It is for this reason that high levels of these additives are required in prior attempts to inhibit the gelling reaction.

The processes provided in this disclosure interdict the gelling reaction after the polymer has become unsaturated and desorbed from the cathode particle surface. An advantage of the processes is that a much smaller number of molecules are required than prior processes attempting to attack the, essentially, infinite supply of LiOH that produced them. The crosslinking reaction, which takes place between two unsaturated polymer chains, occurs when double unsaturations on one chain react with a single unsaturation on another chain to create a ring-structure crosslink. To address this reaction, this disclosure introduces a small molecule, optionally non-polymeric, “dienophile” that will react with the double unsaturation polymer chain (the diene) rendering it incapable of crosslinking. It is believed that any small molecule that reacts with either a single or a double unsaturation will serve this purpose. In some aspects of this disclosure, however, the inventors attack the double unsaturations because they are comparatively rarer than the single unsaturations and may be more efficient targets. A significant benefit to this approach is that useful molecules for this reaction are not necessarily reactive with the cathode material themselves and therefore will not affect the cathode surface during processing or negatively affect cathode performance.

As such, provided in this disclosure are methods of forming a cathode coating material, the processes include forming a cathode slurry by combining a cathode active material, a binder comprising an at least partially halogenated hydrocarbon polymer, a solvent, and an additive suitable for reacting with a double unsaturation when formed on the binder, and intermixing the cathode slurry to produce a cathode coating material. The cathode slurry has a viscosity following the intermixing step. The target viscosity range for the slurry depends on the coater that is subsequently used for coating the cathode electrode. For example, for reverse comma type coaters, the target viscosity range is below 10,000 cP. The viscosity is optionally 5000 cP or less at a shear rate of 20 1/s. Optionally, viscosity increases no more than 50% at 80 1/s shear rate from its lowest point in 24 hours, optionally from its point of initial mixing of binder with electrochemically active material by no more than 50% at 80 1/s shear rate from its lowest point in 24 hours. The viscosity is optionally achieved following intermixing the cathode slurry for a mixing time of 15-30 minutes or greater. In some aspects, the viscosity remains within the coating window (capable of being effectively coated) of a desired coater for use with making of an electrode (as recognized by one of ordinary skill in the art) for at least 24 hours after mixing.

In the processes as provided herein the one or more additives are capable of reacting with a conjugated unsaturation on a halogenated hydrocarbon polymer chain of the binder so as to reduce the rate of crosslinking of the binder (e.g. gelling). The additive may be characterized as a dienophile meaning that the additive is capable of reacting with a conjugated unsaturation in a carbon chain by a Diels Alder reaction. Suitable dienophile additives are capable of taking part in a Diels Alder reaction such that the reaction interferes with the crosslinking of the binder, optionally where the binder includes dehydrohalogenated PVDF polymers, as an example. In principle, since the Diels Alder reaction takes place between a monounsaturation (dienophile) and a double conjugated unsaturation (diene) of two binder carbon polymer chains thus causing a crosslink, the additive can be a small molecule (e.g. less than 500 Da) dienophile suitable to neutralize the interchain crosslinking event. It is noted that small molecule dienes that are reactive enough to be effective at attacking the single unsaturation on the other reactant in the gelling reaction tend to be volatile, difficult to handle and often toxic, such that the small molecule dienes are optionally excluded in some aspects as provided herein.

Dienophiles have the advantage of attacking the binder diene that is statistically rarer than the monounsaturated polymer and, therefore, can be effective at a lower level than molecules that would react with the monounsaturated polymer. The additive may be further improved by the inclusion of one or more electron withdrawing groups either conjugated to the single unsaturation or otherwise capable of promoting withdrawal of electrons from the unsaturation in the dienophile such that the carbons of the double bond become slightly electron poor. The presence of these one or more electron withdrawing groups increases the reactivity of the dienophile for the corresponding diene on the binder. Illustratively, an electron withdrawing group may include or be a halogen. Illustratively a halogen electron withdrawing group is or includes a chlorine or fluorine. Optionally, an electron withdrawing group is or includes a fluorine. Illustrative examples of electron withdrawing groups include —F, —Cl, —Br, —I, —COR, —CO₂R, —COCl, —NO₂, —CN, —CF₃, or —SO₃H, where R is H or an alkyl radical. In some aspects, an electron withdrawing group excludes Cl.

A wide variety of chemical species can serve as an additive in the processes and compositions as provided herein. A dienophile is optionally a linear, branched, or cyclic molecule of 2 or more carbons that includes at least one unsaturation capable of reacting with a diene in a Diels Alder reaction. Optionally, a dienophile is a C₂-C₆, optionally C₅-C₆ substituted or unsubstituted linear or cyclic molecule optionally substituted with a N, O, S, or a halogen, optionally including one or more electron withdrawing groups. In some aspects, a dienophile is or includes a 5-6 membered ring. A ring structure may include one or more heteroatoms within the ring itself. Illustratively one or more heteroatoms include an N, O, or S. In some aspects, a ring includes a substituent at one more locations of the ring wherein a substituent is attached to the ring backbone and is not a member of the ring backbone itself. Optionally a substituent is or includes an electron withdrawing group. Optionally, a substituent is or includes O, N, S, P, or a halogen optionally Cl or F. In some aspects, a substituent is one or more electron withdrawing groups on a 5 or 6 membered ring. Optionally, the substituent is located at position 2, 3, 5 or 6 on the ring. Optionally, a substituent is or includes —F, —Cl, —Br, —I, —COR, —CO₂R, —COCl, —NO₂, —CN, —CF₃, or —SO₃H, where R is H or an alkyl radical. In some aspects, a substituent excludes Cl.

Optionally, an additive is or includes a member of the benzoquinone family. Members of the benzoquinone family are recognized as including a six membered ring comprising at least one unsaturation and with at least one substituent of O. In some aspects, an additive is a fully conjugated cyclic dione. Illustrative examples include, but are not limited to: 1,2-benzoquinone; 1,4-benzoquinone; 1,4-naphthoquinone; 9,10-anthraquinone; chloranil; fluoranil; lawsone; alizarin; or 2,3-dichloro-5,6-dicyano-1,4-benzoquinone (DDQ). An additive member of the benzoquinone family may include one or more substituents including but not limited to —F, —Cl, —Br, —I, —COR, —CO₂R, —COCl, —NO₂, —CN, —CF₃, or —SO₃H, where R is H or an alkyl radical.

Optionally, an additive is an anhydride recognized as any molecule, linear, cyclic, or combinations thereof that includes an anhydride functional group defined as two acyl groups bonded to the same oxygen atom, whereby the two acyl groups are optionally joined in ring formation. An illustrative example of an anhydride includes maleic anhydride.

Illustrative examples of an additive suitable for use as a gelling inhibitor as used in the processes as provided herein include those presented in Table 1.

TABLE 1
Exemplary Additives

| Compound | Diene | Structure | Dienophile Strength/Reason |
|---|---|---|---|
| 1 | Cyclohexene | 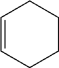 | Weak. Electron Donating groups of CH₂ |
| 2 | Benzoquinone | 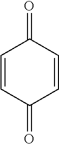 | Moderate. Electron withdrawing groups of ketone |
| 3 | Fluoranil | 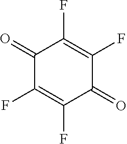 [SMILES: O=C1C(F)=C(F)C(=O)C(F)=C1F] | Strong. Added fluorine electron withdrawing groups |
| 4 | Maleic Anhydride | 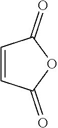 | Strong. Significant electron withdrawing character of anhydride combined with added strain and lack of steric hindrance to double bond |

A cathode coating slurry optionally contains more than one additive. Optionally, a cathode coating slurry includes 1, 2, 3, 4, or more additives where each additive is capable of reacting with a diene on binder. An additive is optionally presented in the cathode coating slurry at a concentration suitable to prevent gelling during intermixing of the cathode active material. Illustratively, an additive is present at from 100 parts per million (ppm) to 10000 ppm or any value or range there between with the ppm relative to the cathode active material in the slurry. Optionally, an additive is present at from 100 ppm to 2000 ppm, optionally 300 ppm to 2000 ppm, optionally 500 ppm to 1000 ppm. An amount of additive is optionally sufficient to prevent an increase in viscosity of more than 1000 cps for 100 seconds or more following mixing of the cathode coating slurry in a Thinky mixer using a more aggressive mixing regime of 2 minutes at 2000 RPM followed by 2200 RPM for 30 seconds.

A cathode coating material includes a binder such as to induce improved structural integrity to a cathode when blended into a cathode coating slurry. A binder as used herein is one that will react with a hydroxide on the surface of a cathode active material particle so as to produce a single or double (or greater) unsaturation on the binder. Illustrative binders include a polymeric material that includes a substituted or unsubstituted hydrocarbon chain. Examples of binders include polymers that include on a carbon chain backbone one or more halogens and one or more hydrogens such that the polymer may react with lithium hydroxide to form an unsaturation, or a double conjugated unsaturation. Illustrative examples of such binders include at least partially halogenated hydrocarbon polymer binders (i.e. including on the carbon backbone of a polymer with both hydrogen and one or more halogens). Illustrative examples of a binder include various fluorocarbon resins, for example polyvinylidene difluoride (PVDF), polyvinyl fluoride (PVF), polyethylenetetrafluoroethylene (ETFE). An example of a suitable PVDF binder is available from Kureha and sold as K1100. Optionally, the binder may be present in the cathode coating slurry in an amount ranging from about 0.5 wt. % to about 3.0 wt. %, from about 1.0 wt. % to about 2.5 wt. %, or from about 1.5 wt. % to about 2.0 wt. %. Optionally, the binder may be present in the dry cathode coating (e.g. relative to non-solvent components) in an amount ranging from about 1 wt. % to about 10 wt. %, from about 2 wt. % to about 8 wt. %, or from about 4 wt. % to about 6 wt. % A cathode coating slurry can also include other optional additives.

A cathode coating slurry includes a solvent. It is believed that preventing gelling by the processes as provided herein are independent of solvent type. The solvent is optionally one with suitable volatility so as to substantially evaporate during the desired time for formation of a cathode. Illustrative examples of solvents include, but are not limited to: N,N-dimethylformamide (DMF); N,N-dimethylacetamide (DMAc); N-2-methyl pyrrolidone (NMP); tetrahydrofuran (THF); acetone; or methanol. A solvent is optionally added to the other components of the cathode coating slurry such that the slurry is from 50 to 97 percent by weight solids. Traditional amounts of solvent used in traditional cathode slurries are suitable for use in the provided processes. Optionally, the solvents may be present in the cathode coating slurry in an amount ranging from about 20 wt. % to about 50 wt. %, from about 30 wt. % to about 50 wt. %, from about 35 wt. % to about 50 wt. %, or from about 38 wt. % to about 45 wt. %.

In some aspects, a cathode coating slurry includes one or more oxidation-resistant, electrically-conductive carbon additives, such as synthetic, non-expanded oxidation-resistant graphite, graphitized carbon black, vapor phase grown carbon fibers, and/or carbon nanofibers. Optionally, the electrically-conductive carbon additives is present at a level of between 1 wt % and 20 wt %, optionally between 3 wt % and 10 wt %, of the total cathode coating slurry.

A cathode coating slurry includes one or more cathode active materials. A cathode active material is a material capable of reversibly intercalating lithium. In some embodiments, the cathode active material is or includes a polycrystalline or single crystal lithiated metal oxide with a layered structure defined by the composition

Li₁₊ₓMO_{2+y} (I)

and optionally a, electrode, cell or battery formed therefrom, where −0.1≤x≤0.3 and −0.3≤y≤0.3. In some aspects, x is −0.1, optionally 0, optionally 0.1, optionally 0.2, or optionally 0.3. Optionally, x is greater than or equal to −0.90, −0.80, −0.70, −0.60, −0.50, −0.40, −0.30, −0.20, −0.10, −0.09, −0.08, −0.07, −0.06, −0.05, −0.04, −0.03, −0.02, −0.01, 0.00, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, or 0.30. In some aspects, y is −0.3, optionally −0.2, optionally −0.1, optionally 0, optionally 0.1, optionally 0.2, or optionally 0.3. Optionally, y is greater than or equal to −0.30, −0.29, −0.28, −0.27, −0.26, −0.25, −0.24, −0.23, −0.22, −0.21, −0.20, −0.19, −0.18, −0.17, −0.16, −0.15, −0.14, −0.13, −0.12, −0.11, −0.10, −0.09, −0.08, −0.07, −0.06, −0.05, −0.04, −0.03, −0.02, −0.01, 0.00, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, or 0.3.

It is appreciated that in some aspects Li need not be exclusively Li, but may be partially substituted with one or more elements selected from the group consisting of Mg, Sr, Na, K, and Ca. The one or more elements substituting Li, are optionally present at 10 mol % or less, optionally 5 mol % or less, optionally 3 mol % or less, optionally no greater than 2 mol %, where percent is relative to total Li in the material.

M as provided in the cathode active material optionally is or includes Ni. The amount of Ni in the is optionally from 0 atomic percent to 100 atomic percent (at %) of total M. Optionally, the Ni component of M is greater than or equal to 75 at % of the total M. Optionally, the Ni component of M is greater than or equal to 80 at %. Optionally, the Ni component of M is greater than or equal to 85 at %. Optionally, the Ni component of M is greater than or equal to 90 at %. Optionally, the Ni component of M is greater than or equal to 95 at %. Optionally, the Ni component of M is greater than or equal to 75 at %, 76 at %, 77 at %, 78 at %, 79 at %, 80 at %, 81 at %, 82 at %, 83 at %, 84 at %, 85 at %, 86 at %, 87 at %, 88 at %, 89 at %, 90 at %, 91 at %, 92 at %, 93 at %, 94 at %, 95 at %, 96 at %, 97 at %, 98 at %, 99 at %, 99.5 at %, 99.9 at %, or 100 at %.

In some aspects, M in the cathode active material is Ni alone or in combination with one or more additional elements. The additional elements are optionally metals. Optionally, an additional element may include or be one or more of Al, Mg, Co, Cr, Sb, W, Cu, Ge, Nb, Sc, Zr, Mn, Ca, Sr, Zn, Ti, Y, Cr, Mo, Fe, V, Si, Ga, or B. In particular aspects, the additional element may include Mg, Co, Al, or a combination thereof. Optionally, the additional element may be Mg, Al, V, Ti, B, or Mn, or a combination thereof. Optionally, the additional element is selected from the group consisting of Mg, Al, V, Ti, B, or Mn. Optionally, the additional element selected from the group consisting of Mg, Co, and Al. Optionally, the additional element is selected from the group consisting of Ca, Co, and Al. In some aspects, the additional element is Mn or Mg, or both Mn and Mg. Optionally, the additional element is Mn, Co, Al, or any combination thereof. Optionally the additional element includes Co and Mn. Optionally the additional element is Co and Al. Optionally the additional element is Co.

An additional element may be present in of the cathode active material at an amount of about 1 at % to about 90 at %, specifically about 5 at % to about 80 at %, more specifically about 10 at % to about 70 at % of M in the first composition. Optionally, the additional element may be present in an amount of about 1 at % to about 20 at %, specifically about 2 at % to about 18 at %, more specifically about 4 at % to about 16 at %, of M in the first composition. In some illustrative examples, M is about 75-100 at % Ni, 0-15 at % Co, 0-15 at % Mn, and 0-10 at % additional elements. Illustrative examples of cathode active materials include those illustrated in U.S. Pat. No. 9,209,455.

Optionally, the cathode material may belong to the olivine family including lithium iron phosphate (LFP), lithium manganese phosphate, lithium iron manganese phosphate, lithium cobalt phosphate, lithium iron-cobalt phosphate, lithium nickel phosphate, etc.

In the processes as provided herein, a solvent may be combined with binder and any conductive agent to form a master batch that is fed to a mill where the master batch is milled. The milled master batch may then be filtered to remove larger particles present in the master batch. A double planetary mixer, having a planetary blade and a disperser blade, may then be loaded with the master batch, cathode active material, the additive, and any additional solvent and mixed at a desired shear for a desired time. Mixing may be performed using the planetary blade (120) alone, the disperser blade (125) alone, or a combination of the two.

The cathode coating slurry may then be pumped optionally through a filter and then to a coater where the cathode coating slurry is coated on one or more sides of an electrically conductive substrate so as to form a cathode or portions thereof. The cathode coating slurry may be deposited onto a current collector using a coater such as a slot die coater, roll coater, reverse gravure, screen printer, or other desired system. The cathode coating slurry, in a wet state, may be deposited such that the cathode coating slurry has a thickness of from about 50 micrometers (μm) to about 500 μm, or any value or range therebetween. The coated substrate may then be dried in a dryer to form the final cathode.

In principle, any suitable electrically conductive substrate may be used which can include nickel, steel, titanium, aluminum, carbon-coated aluminum, graphite foil/cloth. The substrate may be a thin, flat, sheet material, such as a foil. The thickness and dimensions of the substrate may be chosen based in intended use as is understood in the art.

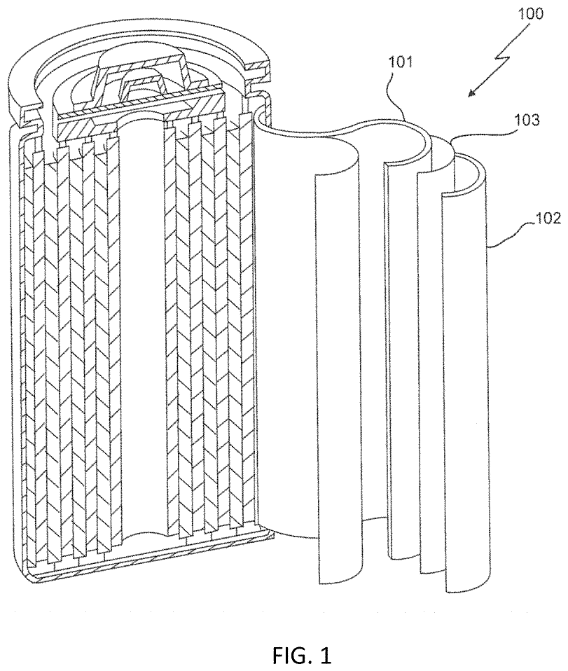

The cathode may be incorporated into an electrochemical cell such as a primary or secondary battery. The battery may be a lithium-ion battery, a lithium-polymer battery, or a lithium battery, for example. As shown in FIG. 1, the battery 100 may include a cathode 101; an anode 102; and a separator 103 interposed between the cathode 101 and the anode 102. The separator may be a microporous membrane, and may comprise a porous film comprising polypropylene, polyethylene, or a combination thereof, or may be a woven or non-woven material such a glass-fiber mat. The anode 102 may comprise a coating on a current collector. The coating may comprise a suitable carbon, such as graphite, coke, a hard carbon, or a mesocarbon such as a mesocarbon microbead, for example. The current collector may be copper foil, for example.

The battery includes an electrolyte that contacts the positive electrode 101, the negative electrode 102, and the separator 103. The electrolyte may include an organic solvent and a lithium salt. The organic solvent may be a linear or cyclic carbonate. Representative organic solvents include: ethylene carbonate; propylene carbonate; butylene carbonate; trifluoropropylene carbonate; γ-butyrolactone; sulfolane; 1,2-dimethoxyethane; 1,2-diethoxyethane; tetrahydrofuran; 3-methyl-1,3-dioxolane; methyl acetate; ethyl acetate; methyl propionate; ethyl propionate; dimethyl carbonate; diethyl carbonate; ethyl methyl carbonate; dipropyl carbonate; methylpropyl carbonate; or any combination thereof. In another embodiment the electrolyte is a polymer electrolyte.

Representative lithium salts include LiPF₆, LiBF₄, LiAsF₆, LiClO₄, LiCF₃SO₃, Li(CF₃SO₂)₂N, LiN(SO₂C₂F₅)₂, LiSbF₆, LiC(CF₃SO₂)₃, LiC₄F₉SO₃, and LiAlCl₄. The lithium salt may be dissolved in the organic solvent. A combination comprising at least one of the foregoing can be used. The concentration of the lithium salt can be 0.1 to 2.0 M in the electrolyte.

The battery may have any suitable configuration or shape, and may be cylindrical or prismatic.

Also provided herein are various formation materials suitable for use in generating a cathode slurry or cathode coating material as provided herein. A formation material includes one or more additives suitable for reacting with a conjugated double unsaturation on a halogenated hydrocarbon polymer and one more of a cathode active material, conductive additive, a binder, or a solvent.

In some aspects, a formation material includes a cathode active material and one or more dienophile additives suitable for reacting with a conjugated double unsaturation on a halogenated hydrocarbon polymer. The additive is optionally a dienophile that is optionally a linear, branched, or cyclic molecule of 2 or more carbons that includes at least one unsaturation capable of reacting with a diene in a Diels Alder reaction. Optionally, a dienophile is a C₂-C₆, optionally C₅-C₆, substituted or unsubstituted linear or cyclic molecule optionally substituted with a N, O, S, or a halogen. Optionally, a dienophile includes one or more electron withdrawing groups conjugated to the double bond. A dienophile additive is optionally present at 100 parts per million (ppm) to 10000 ppm or any value or range there between with the ppm relative to the cathode active material. Optionally, an additive is present at from 100 ppm to 2000 ppm, optionally 300 ppm to 2000 ppm, optionally 500 ppm to 1000 ppm. In these formation materials, a cathode active material optionally is or includes a polycrystalline lithiated metal oxide with a layered structure defined by the composition

Li₁₊ₓMO_{2+y} (I)

where −0.1≤x≤0.3 and −0.3≤y≤0.3. In some aspects, x is −0.1, optionally 0, optionally 0.1, optionally 0.2, or optionally 0.3. Optionally, x is greater than or equal to −0.90, −0.80, −0.70, −0.60, −0.50, −0.40, −0.30, −0.20, −0.10, −0.09, −0.08, −0.07, −0.06, −0.05, −0.04, −0.03, −0.02, −0.01, 0.00, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, or 0.30. In some aspects, y is −0.3, optionally −0.2, optionally −0.1, optionally 0, optionally 0.1, optionally 0.2, or optionally 0.3. Optionally, y is greater than or equal to −0.30, −0.29, −0.28, −0.27, −0.26, −0.25, −0.24, −0.23, −0.22, −0.21, −0.20, −0.19, −0.18, −0.17, −0.16, −0.15, −0.14, −0.13, −0.12, −0.11, −0.10, −0.09, −0.08, −0.07, −0.06, −0.05, −0.04, −0.03, −0.02, −0.01, 0.00, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, or 0.3. The cathode active material optionally includes Ni as a constituent M at greater than or equal to 75 at % of the total M. Optionally, the Ni component of M is greater than or equal to 80 at %. Optionally, the Ni component of M is greater than or equal to 85 at %. Optionally, the Ni component of M is greater than or equal to 90 at %. In some aspects, M in the cathode active material is Ni alone or in combination with one or more additional elements. The additional elements are optionally metals. Optionally, an additional element may include or be one or more of Al, Mg, Co, Cr, Sb, W, Cu, Ge, Nb, Sc, Zr, Mn, Ca, Sr, Zn, Ti, Y, Cr, Mo, Fe, V, Si, Ga, or B. An additional element is optionally present at about 1 at % to about 90 at %, specifically about 5 at % to about 80 at %, more specifically about 10 at % to about 70 at % of M in the first composition.

In other aspects as provided herein a formation material includes a conductive additive and one or more dienophile additives suitable for reacting with a conjugated double unsaturation on a halogenated hydrocarbon polymer. The additive is optionally a dienophile that is optionally a linear, branched, or cyclic molecule of 2 or more carbons that includes at least one unsaturation capable of reacting with a diene in a Diels Alder reaction. Optionally, a dienophile is a C₂-C₆, optionally C₅-C₆, substituted or unsubstituted linear or cyclic molecule optionally substituted with a N, O, S, or a halogen. Optionally, a dienophile includes one or more electron withdrawing groups conjugated to the double bond. A dienophile additive is optionally present at 1000 parts per million (ppm) to 10000 ppm or any value or range there between with the ppm relative to the cathode active material in the slurry. Optionally, an additive is present at from 1000 ppm to 20000 ppm, optionally 3000 ppm to 20000 ppm, optionally 5000 ppm to 10000 ppm. In these formation materials, one or more oxidation-resistant, electrically-conductive carbon additives is also present. An electrically-conductive carbon additive is optionally a synthetic, non-expanded oxidation-resistant graphite, graphitized carbon black, vapor phase grown carbon fibers, and/or carbon nanofibers. Optionally, the electrically-conductive carbon additive is present as the remainder of the total formation material.

In other aspects as provided herein a formation material includes a binder and one or more dienophile additives suitable for reacting with a conjugated double unsaturation on a halogenated hydrocarbon polymer. The additive is optionally a dienophile that is optionally a linear, branched, or cyclic molecule of 2 or more carbons that includes at least one unsaturation capable of reacting with a diene in a Diels Alder reaction. Optionally, a dienophile is a C₂-C₆, optionally C₅-C₆, substituted or unsubstituted linear or cyclic molecule optionally substituted with a N, O, S, or a halogen. Optionally, a dienophile includes one or more electron withdrawing groups conjugated to the double bond. A dienophile additive is optionally present at 1000 parts per million (ppm) to 100000 ppm or any value or range there between with the ppm relative to the cathode active material in the slurry. Optionally, an additive is present at from 1000 ppm to 20000 ppm, optionally 3000 ppm to 20000 ppm, optionally 5000 ppm to 10000 ppm. In these formation materials, one or more binders as provided herein is also present. Illustrative binders include a polymeric material that includes a substituted or unsubstituted aliphatic hydrocarbon chain. Examples of binders include polymers that include on a carbon chain backbone one or more halogens and one or more hydrogens such that the polymer may react with lithium hydroxide to form an unsaturation, or a double conjugated unsaturation. Illustrative examples of such binders include hydrohalogenated binder. Illustrative examples include various fluorocarbon resins, for example polyvinylidene difluoride (PVDF), polyvinyl fluoride (PVF), polyethylenetetrafluoroethylene (ETFE).

Any of the formation materials as provided herein, are provided or further include one or more solvents suitable for use in the formation of a cathode coating slurry. Illustrative examples of solvents include, but are not limited to: N,N-dimethylformamide (DMF); N,N-dimethylacetamide (DMAc); N-2-methyl pyrrolidone (NMP); tetrahydrofuran (THF); acetone; or methanol. A solvent is optionally added to the other components of the formation material at from 50 to 90 percent by weight.

Various aspects of the present invention are illustrated by the following non-limiting examples. The examples are for illustrative purposes and are not a limitation on any practice of the present invention. It will be understood that variations and modifications can be made without departing from the spirit and scope of the invention.

### EXAMPLES

### Gelling Tests

For all gelling tests, cathode coating slurries were made using a standard formulation which was 94% active material (High-Nickel cathode product 88% Ni), 3% PVDF (Kureha K1100) and 3% conductive carbon (Denka Black) where percents are weight percents. Slurries were made with NMP such that they were 70% solids by combining a “master batch” of NMP, conductive carbon and PVDF with the active material and some additional NMP. Master batches are prepared ahead of time and in bulk and jar milled for 3 days in a polymer jar and with ¾″ drum ceramic media. This method of pre-dispersion of the conductive carbon is common and facilitates subsequent blending of cathode coating slurries. When the master batch, active and additional NMP are combined, they are mixed in a “Thinky” mixer once at 2000 RPM for one minute.

The gelling test consisted of placing the slurry on a cone and plate rheometer and shearing at 150 1/S at 45° C. while measuring the viscosity. This assessment of shear has the benefit of providing a uniform shear to the entire slurry and measuring its effect over time. The high temperature and high shear are intended to accelerate the gelling reaction.

The gelling reaction was also accelerated by making a model cathode material where gelling would clearly be a problem. Therefore, an NCA cathode material was made from a very-small-particle transition metal hydroxide precursor. This precursor was combined with micronized LiOH in an amount such that there was an atomic ratio of 1.03 for lithium to transition metal. The two powders were shaken on a paint shaker for 10 minutes, placed in crucibles and then calcined in air for 6 hours at 680° C. The resulting powder had a high surface area (inferred by small particle size but not measured) and a high LiOH content around 0.3 wt %.

### Electrochemical Testing

Electrochemical testing was conducted on a separate cathode material. This was done because the cathode product made for the gelling test showed poor cycling characteristics and thus may mask the possible impact of the gelling additives on the cycling performance. Instead, a commercial NCA product was used.

The amount of each additive to include was set by its performance at gelling inhibition. Some were required at relatively high levels to inhibit to the same degree as others present at relatively lower levels. The additives were added to the coating slurries as described above, mixed in the Thinky mixer using a more aggressive mixing regime of 2 minutes at 2000 RPM followed by 2200 RPM for 30 seconds. Slurries were then coated onto aluminum foil with a 100 μm drawdown bar and dried in a 130° C. oven for 30 minutes. Two-inch wide strips were cut from this coating and pressed at 40° C. in a roller press at 100 lbs pressure. Disk ⅝″ diameter electrodes were then cut from this strip with a punch and paired with an MCMB anode. Coin cells were then constructed and these were cycled at 45° C. for 200 cycles.

### Example 1: Dienophile—Cyclohexene

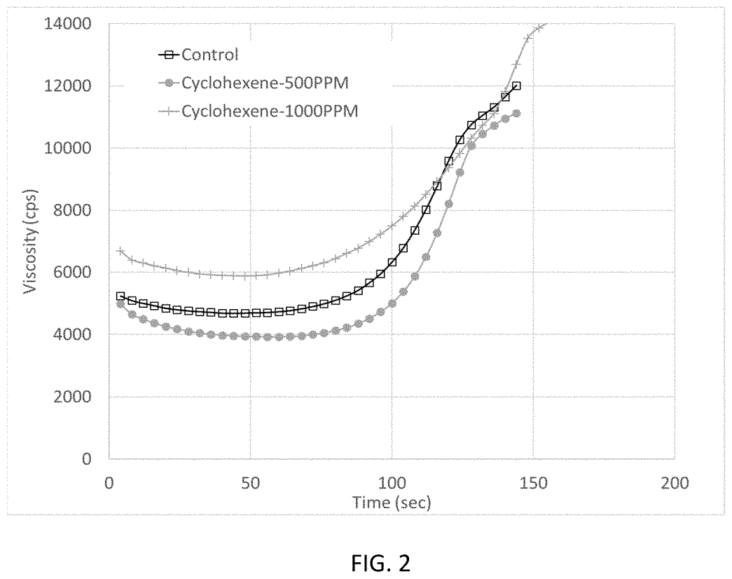

This example was produced to demonstrate the effect of a weak dienophile on inhibition of gelling. The cyclohexene was formulated into the gelling test as described above at 500 ppm and 1000 ppm relative to the active cathode material. The plot in FIG. 2 shows the rate of viscosity increase with time for the two levels of additive and a control with no additive. At 500 ppm, the rate of increase in viscosity is roughly the same as the control. At 1000 ppm the slope of the increase is slightly less between 100 and 150 seconds than the control and so some benefit is seen but a significant extension of “workable” (below 12000 cps) is not observed.

### Example 2: Dieneophile—Benzoquinone

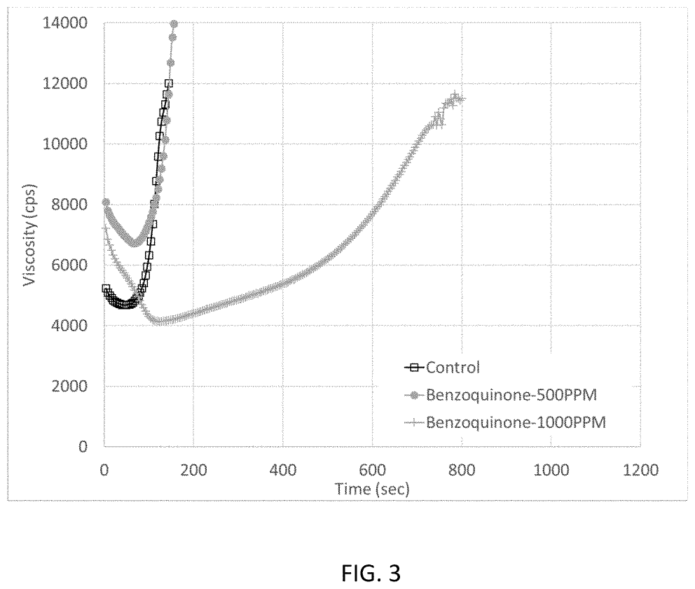

A more effective dienophile and gelling inhibitor of benzoquinone was tested for its ability to prevent gelling. A cathode coating slurry was formulated into the gelling test as described above with the benzoquinone present at 500 ppm and 1000 ppm relative to the active cathode material. The plot in FIG. 3 shows the rate of viscosity increase with time for the two levels of additive and a control with no additive. At 500 ppm a slight advantage is seen over the control whereby the slope of the viscosity/time curve is slightly lower between 75 seconds and 125 seconds. However, at 1000 ppm, a significant extension of workable slurry to around 700 seconds is observed.

### Example 3: Dienophile—Fluoranil

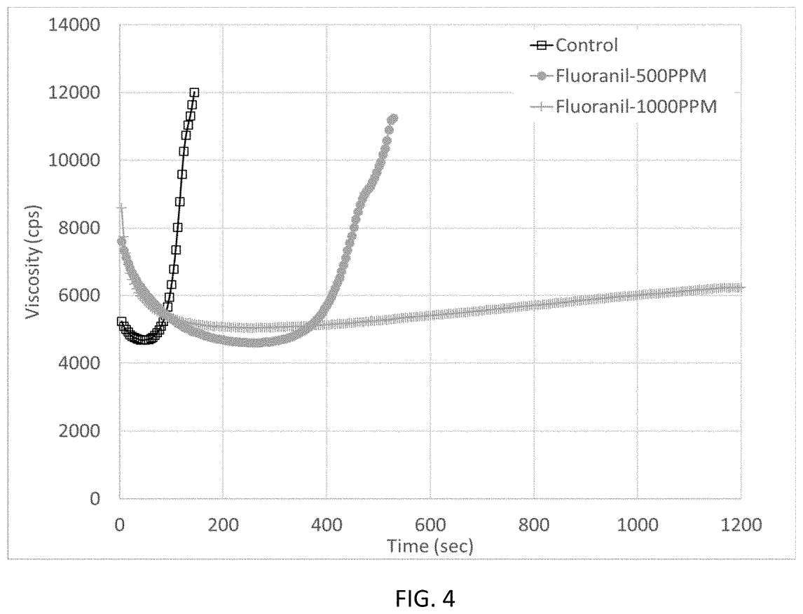

This material was expected to be an improvement over the benzoquinone because of the addition of electron withdrawing fluorines on the additive. A cathode coating slurry including fluoranil was formulated into the gelling test as described above with the fluoranil present at 500 ppm and 1000 ppm relative to the active cathode material. The plot in FIG. 4 shows the rate of viscosity increase with time for the two levels of additive and a control with no additive. Indeed, at 500 ppm, the increase in viscosity does not begin until around 350 seconds. This is roughly 5× the stability time of the same level of benzoquinone. At 1000 ppm the slurry begins to increase in viscosity around the same time but extremely slowly such that the slurry is still workable by the end of the test at 1200 seconds. These results indicate that roughly 5× the stability of benzoquinone was achieved using fluoranil.

### Example 4: Dienophile—Maleic Anhydride

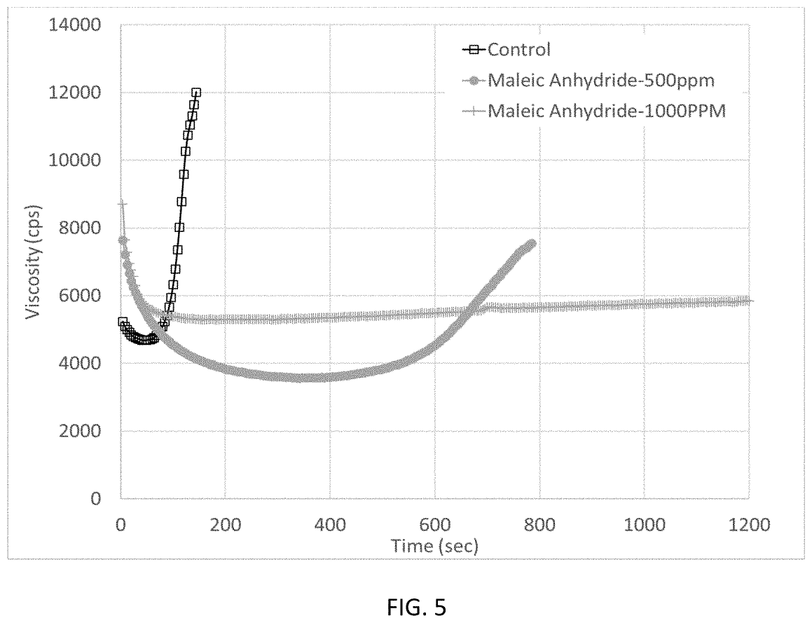

Maleic anhydride has the additional advantage of being fairly stable and nontoxic as well as a strong dienophile due to the significant electron withdrawing nature of the structure. Maleic anhydride was formulated into the gelling test as described above at 500 ppm and 1000 ppm relative to the active cathode material. The plot in FIG. 5 shows the rate of viscosity increase with time for the two levels of additive and a control with no additive. The viscosity increase does not begin until around 450 seconds for the 500 ppm formulation illustrating prevention of gelling of around 6.5× better than the benzoquinone. Given the results above, this additive was formulated into the electrochemical test at 6.5× less than the benzoquinone or 115 ppm.

### Example 5: Comparative Example of Acid Gelling Inhibitor—Oxalic Acid

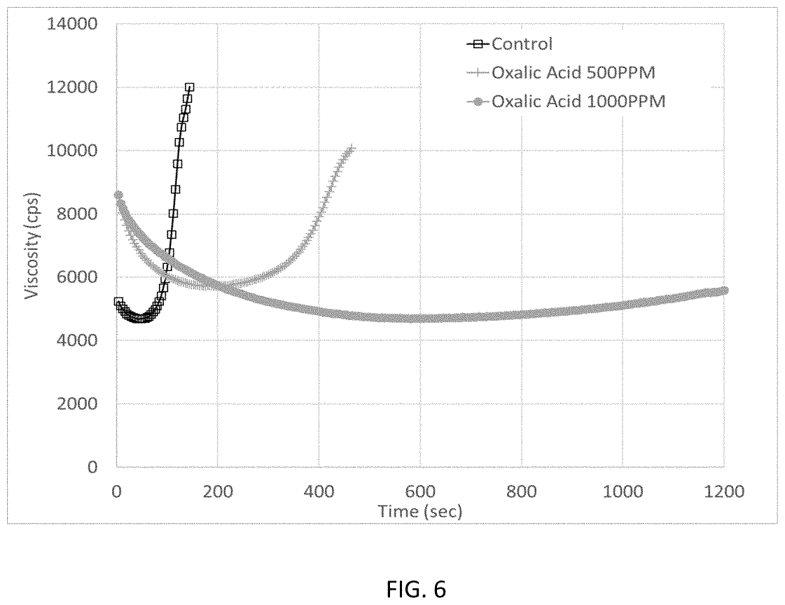

Oxalic acid is known to inhibit gelling in cathode coating slurries and does so by direct acid/base reaction with lithium hydroxide. As such it interdicts the reaction at an earlier point, before dehydrohalogenation. The drawback of this additive is the remaining acid left in the coating which can have deleterious impact on cell cycling. Also, because there is more LiOH than unsaturations that ultimately form in the polymer, it must be used at a higher level than the most effective dienophile. The plot presented in FIG. 6 shows the gelling propensity for oxalic acid at two levels. The viscosity increase does not begin until around 200 seconds for the 500 ppm formulation around 2.5× better than the benzoquinone.

### Example 6: Blended Gelling Inhibitor

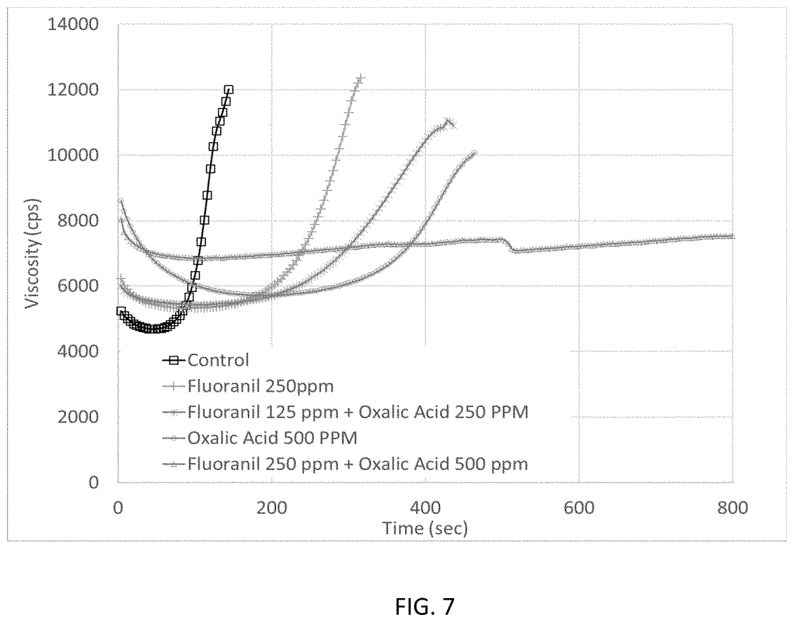

In this example, two types of inhibitor were formulated simultaneously, an acid (oxalic) and a dienophile (fluoranil.) The presented in FIG. 7 shows the effect of two levels of this combination versus control formulations with just the single inhibitors. The formulation of 250 ppm of oxalic acid with 125 ppm of fluoranil produces a gelling rate almost as effective as 500 ppm of oxalic acid alone. Also, 500 ppm oxalic acid with 250 ppm fluoranil produces an almost-flat line showing essentially no gelling, a result previously shown to only be attainable by 1000 ppm additive.

### Example 7: Gelling Inhibition of Various Cathode Materials

The gelling of electrode slurries is increasingly a problem encountered by battery producers as cathode materials have ever increasing levels of nickel. Thus, NCA, NCM and other lithium nickel oxide variants all this problem as nickel rises above 80 mol %. As illustrated in the following figures for gelling inhibition 250 ppm fluoranil is effective at inhibiting gelling with examples of each of these materials.

### Example 7A: Gelling Inhibition of gNCA

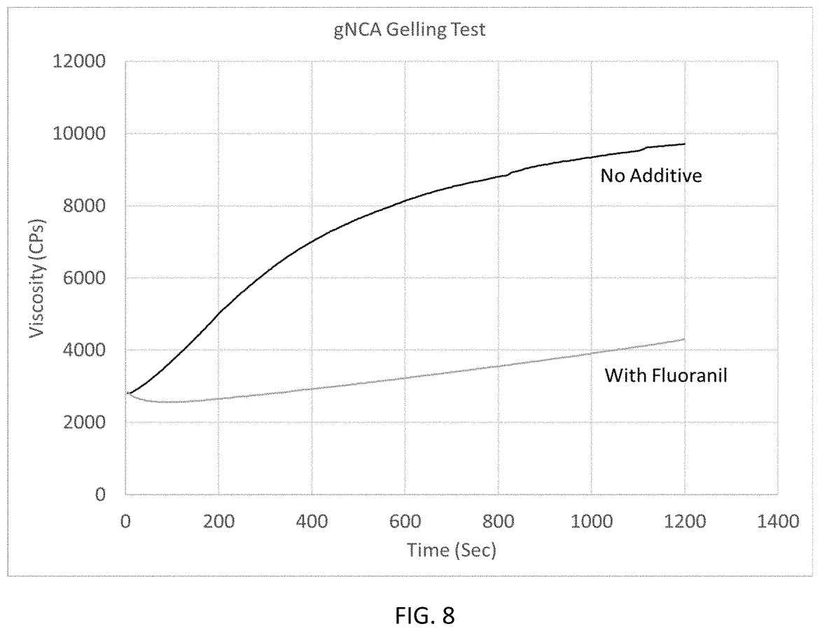

gNCA is a grain boundary enriched ultra-high nickel cathode product. In this case, this sample has a small particle size of 5 μm and also has high surface area. These characteristics can present a challenge with respect to gelling. The plot in FIG. 8 illustrates that with the fluoranil additive at 250 ppm, gelling is significantly reduced.

### Example 78: Commercial NCA

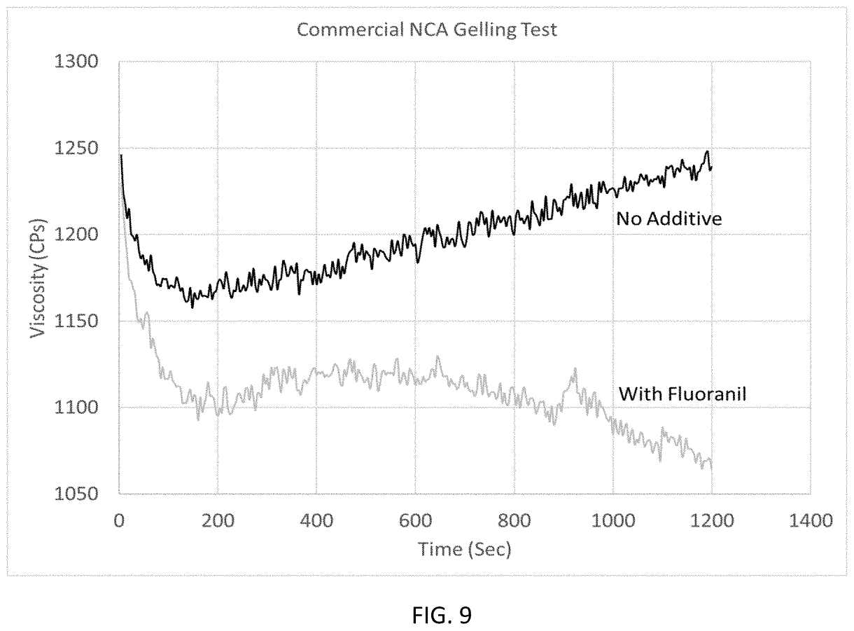

FIG. 9 shows gelling inhibition for a commercial NCA product. This material is 15% Co and 3% Al and the remainder of metal is Ni. This material was also used in the electrochemical testing of the gelling additives in Example 8 as follows. As illustrated in FIG. 9, a gelling effect is seen with no additive but this was shut down by the fluoranil additive.

### Example 7C

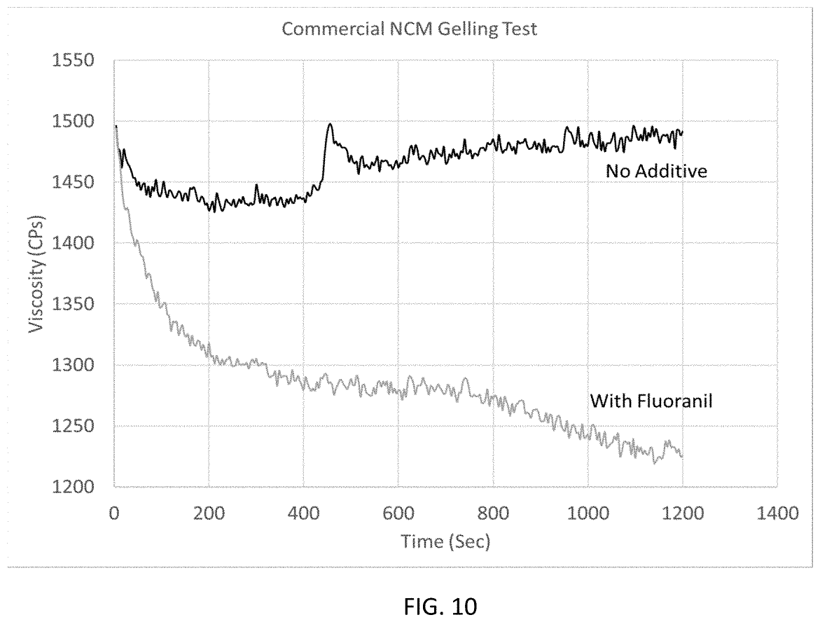

FIG. 10 illustrates gelling inhibition for a commercial NCM product. This material is 10% Co, 10% Mn and the remainder of M is Ni. Here, a gelling effect is seen with no additive but this was shut down by the fluoranil additive.

### Example 8: Electrochemical Impact of Gelling Additives

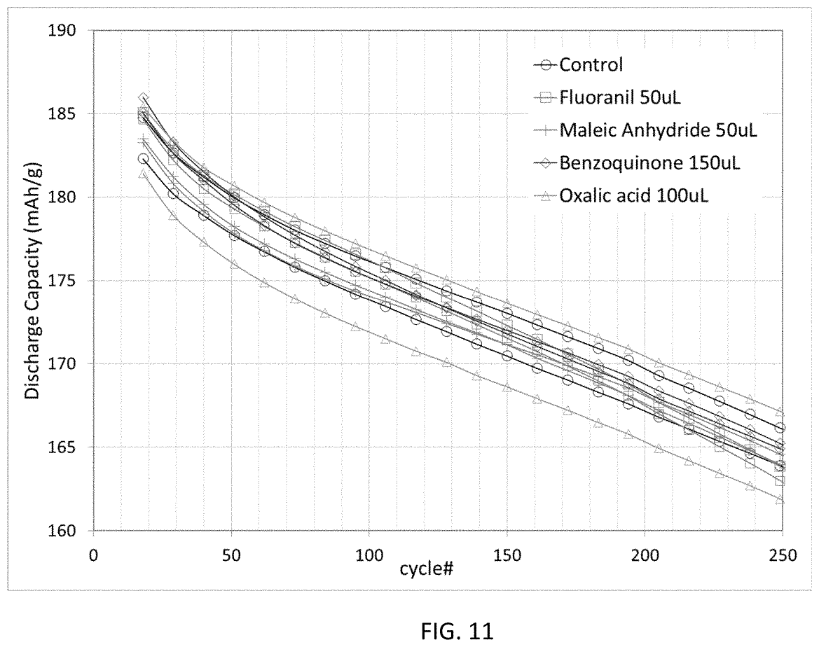

As described in the electrochemical testing section above, gelling inhibitors were formulated into an NCA electrode at levels deemed sufficient given their effectiveness at inhibiting gelation. These were then built into lithium ion cells and cycled at 45° C. for 300 cycles. FIG. 11 shows the capacity fade as a function of cycle number for various additives and levels performed in duplicate. It is difficult to distinguish between the curves because there is such consistency and lack of performance deviation between electrodes with additives and the control without. Thus it is demonstrated that the new dienophile additives can be used without significantly impacting the functioning of the electrodes so produced.

The forgoing description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Various modifications of the present invention, in addition to those shown and described herein, will be apparent to those skilled in the art of the above description. Such modifications are also intended to fall within the scope of the appended claims.

It is appreciated that all reagents are obtainable by sources known in the art unless otherwise specified. Methods of nucleotide amplification, cell transfection, and protein expression and purification are similarly within the level of skill in the art.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A process of forming a cathode coating material, the process comprising:
forming a cathode slurry by combining a cathode active material, a binder comprising an at least partially halogenated hydrocarbon polymer, a solvent, and an additive capable of reacting with a single or double unsaturation when formed on the binder;
intermixing the cathode slurry to produce a cathode coating material.

2. The process of claim 1 wherein the additive is capable reacting with a double unsaturation when formed on said binder so as to reduce a rate of crosslinking of the binder.

3. The process of claim 1 wherein within the cathode slurry the binder comprises one or more conjugated dienes.

4. The process of claim 3 wherein the one or more conjugated dienes are formed by reaction of the binder with the cathode active material.

5. The process of claim 1 wherein the additive is a dienophile.

6. The process of claim 5 wherein the additive comprises one or more electron withdrawing groups conjugated to an unsaturation between two carbons.

7. The process of claim 1 wherein the additive comprises an unsaturation between two carbons.

8. The process of claim 7 wherein the additive comprises one or more electron withdrawing groups conjugated to the unsaturation.

9. The process of claim 7 wherein the additive is comprises a 5-6 membered ring, wherein said unsaturation is within said ring.

10. The process of claim 9 wherein the 5-6 membered ring comprises a heteroatom selected from the group consisting of an N, O, or S.

11. The process of claim 9 wherein the additive is a benzoquinone wherein the one or more electron withdrawing groups is at position 2, 3, 5 or 6.

12. The process of claim 7 wherein the electron withdrawing groups comprise a halogen.

13. The process of claim 11 wherein the halogen is a fluorine.

14. The process of claim 7 wherein the additive comprises an anhydride.

15. The process of claim 1 wherein the binder comprises PVDF.

16. The process of claim 1 wherein the solvent comprises NMP.

17. The process of claim 1 wherein the cathode active material is defined by the formula LiₓMO₂ wherein x is from 0.9 to 1.3 or less than 0.6, and M comprises one or more transition metals.

18. The process of claim 17 wherein M comprises Ni at 10 mole % or greater relative to total M.

19. The process of claim 17 wherein Ni is 50 mole % or greater.

20. The process of claim 17 wherein Ni is 80 mole % or greater.

21. The process of claim 17 wherein M comprises one or more of Ni, Co, Mn, Mg, Ti, Cr, Fe, Y, Ga, Sb, W, Sc, Zr, Nb, Mo, Zn, Cu, In, Ge, or Al.

22. The process of claim 17 wherein M comprises Ni and one or more of Co, Al, Ti, Mn, or Mg.

23. A cathode comprising:
an electrically conductive substrate;
a cathode active material,
a binder, and
one or more additives comprising two or more carbons with an unsaturation between the two carbons.

24. The cathode of claim 23 wherein the binder comprises one or more conjugated dienes.

25. The cathode of claim 23 wherein the additive is a dienophile.

26. The cathode of claim 23 wherein the additive comprises an unsaturation between two carbons.

27. The cathode of claim 23 wherein the additive comprises one or more electron withdrawing groups conjugated to the unsaturation.

28. The cathode of claim 27 wherein the electron withdrawing groups comprise a halogen.

29. The cathode of claim 28 wherein the halogen is a fluorine.

30. The cathode of claim 23 wherein the additive is comprises a 5-6 membered ring, wherein said unsaturation is within said ring.

31. The cathode of claim 30 wherein the 5-6 membered ring comprises a heteroatom selected from the group consisting of an N, O, or S.

32. The cathode of claim 30 wherein the additive is a benzoquinone wherein the one or more electron withdrawing groups is at position 2, 3, 5 or 6.

33. The cathode of claim 30 wherein the additive comprises an anhydride.

34. The cathode of claim 23 wherein the binder comprises PVDF.

35. The cathode of claim 23 wherein the cathode active material is defined by the formula LiₓMO₂ wherein x is from 0.9 to 1.3 or less than 0.6, and M comprises one or more transition metals.

36. The cathode of claim 35 wherein M comprises Ni at 10 mole % or greater relative to total M.

37. The cathode of claim 36 wherein Ni is 80 mole % or greater.

38. The cathode of claim 35 wherein M comprises one or more of Ni, Co, Mn, Mg, Ti, Cr, Fe, Y, Ga, Sb, W, Sc, Zr, Nb, Mo, Zn, Cu, In, Ge, or Al.

39. The cathode of claim 35 wherein M comprises Ni and one or more of Co, Al, Ti, Mn, or Mg.

40. An electrochemical cell comprising the cathode of claim 23.
